(19) United States
(12) Patent Application Publication
(10) Pub. No.: US 2022/0243062 A1
(43) Pub. Date: Aug. 4, 2022

(54) Polymer Composition for an Electric Vehicle

(71) Applicant: Ticona LLC, Florence, KY (US)

(72) Inventors: Yuehua Yu, Cincinnati, OH (US); Christopher McGrady, Walton, KY (US)

(21) Appl. No.: 17/575,916

(22) Filed: Jan. 14, 2022

Related U.S. Application Data
(60) Provisional application No. 63/145,674, filed on Feb. 4, 2021.

(51) Int. Cl. C08L 81/02; C08K 7/14

(52) U.S. Cl. CPC C08L 81/02; C08L 2203/20; C08K 7/14

(57) ABSTRACT

A polymer composition that comprises 100 parts by weight of at least one thermoplastic aromatic polymer having a melting temperature of about 250° C. or more; from about 10 to about 80 parts by weight of at least one polyamides and from about 50 to about 250 parts by weight of aluminum hydroxide particles is provided. The polymer composition exhibits a comparative tracking index of about 475 volts or more at a thickness of 3 mm as determined in accordance with IEC 60112:2003 and a tensile modulus of about 75 MPa or more as determined in accordance with ISO Test No. 527-1:2019.

### CROSS REFERENCE TO RELATED APPLICATION

The present application claims filing benefit of U.S. Provisional Patent Application Ser. No. 63/145,674 having a filing date of Feb. 2, 2021, which is incorporated herein by reference in its entirety.

### BACKGROUND OF THE INVENTION

Electric vehicles, such as battery-electric vehicles, plug-in hybrid-electric vehicles, mild hybrid-electric vehicles, or full hybrid-electric vehicles generally have an electric powertrain that contains an electric propulsion source (e.g., battery) and a transmission. Attempts have been made at using plastic materials in the electric vehicle for various components, such as in high voltage connectors, power converter housings, battery pack housings, etc. Unfortunately, however, many conventional polymer compositions lack a sufficient combination of insulative properties (e.g., comparative tracking index (“CTI”)) and mechanical properties. As such, a need currently exists for a polymer composition for use in electric vehicles that can exhibit a high CTI, but also possess good mechanical properties.

### SUMMARY OF THE INVENTION

In accordance with one embodiment of the present invention, a polymer composition is disclosed that comprises 100 parts by weight of at least one thermoplastic aromatic polymer having a melting temperature of about 250° C. or more, from about 10 to about 80 parts by weight of at least one polyamide, and from about 50 to about 250 parts by weight of aluminum hydroxide particles. The polymer composition exhibits a comparative tracking index of about 475 volts or more at a thickness of 3 mm as determined in accordance with IEC 60112:2003 and a tensile strength of about 75 MPa or more as determined in accordance with ISO Test No. 527-1:2019.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 is a schematic illustration of one embodiment of an electric vehicle that may employ the polymer composition of the present invention;

FIG. 2 is a perspective view of one embodiment of a high voltage connector that may be employed in the electric vehicle;

FIG. 3 is a plan view of the high voltage powertrain connector of FIG. 2 in which the first and second connector portions are disengaged; and

FIG. 4 is a plan view of the high voltage powertrain connector of FIG. 2 in which the first and second connector portions are engaged.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a polymer composition for use in an electric vehicle, such as a battery-powered electric vehicle, fuel cell-powered electric vehicle, plug-in hybrid-electric vehicle (PHEV), mild hybrid-electric vehicle (MHEV), full hybrid-electric vehicle (FHEV), etc. The polymer composition contains at least one thermoplastic aromatic polymer having a melting temperature of about 250° C. or more, at least one polyamide, and aluminum hydroxide particles.

Through selective control over the nature and relative concentration of these components, the present inventors have discovered that the resulting polymer composition can achieve a unique combination of insulative properties and good mechanical properties even at relatively small thickness values, such as about 4 millimeters or less, in some embodiments about from about 0.2 to about 3.2 millimeters or less, in some embodiments from about 0.4 to about 1.6 millimeters, and in some embodiments, from about 0.4 to about 0.8 millimeters. The insulative properties of the polymer composition may be characterized by a high comparative tracking index (“CTI”), such as about 475 volts or more, in some embodiments about 500 volts or more, in some embodiments about 525 volts or more, in some embodiments about 550 volts or more, in some embodiments about 580 volts or more, and in some embodiments, about 600 volts or more, as determined in accordance with IEC 60112:2003 at a part thickness such as noted above (e.g., 3 millimeters). While exhibiting a high CTI value, the composition may still exhibit good tensile properties. For example, the polymer composition may exhibit a tensile strength of about 75 MPa or more, in some embodiments about 80 MPa or more, in some embodiments about 85 MPa or more, in some embodiments from about 90 MPa to about 200 MPa, and in some embodiments, from about 100 to about 150 MPa, as determined at a temperature of 23° C. in accordance with ISO Test No. 527:2019 (technically equivalent to ASTM D638-14). The tensile modulus may likewise be about 15,000 MPa or more, in some embodiments about 20,000 MPa or more, and in some embodiments, from about 21,000 to about 30,000 MPa, as determined in accordance with ISO Test No. 527:2019. The polymer composition may also exhibit a Charpy notched impact strength of about 3 kJ/m² or more, in some embodiments from about 3 to about 25 kJ/m², and in some embodiments, from about 3.5 to about 10 kJ/m², measured at 23° C. according to ISO Test No. 179-1:2010 (technically equivalent to ASTM D256-10, Method B).

Various embodiments of the present invention will now be described in more detail.

### I. Polymer Composition

A. Thermoplastic Aromatic Polymer

Generally speaking, the polymer composition contains one or more thermoplastic aromatic polymers, generally in an amount of from about 5 wt. % to about 50 wt. %, in some embodiments from about 10 wt. % to about 40 wt. %, and in some embodiments, from about 15 wt. % to about 30 wt. % of the entire polymer composition. Such polymers are generally considered “high performance” polymers in that they are selected to have a relatively high glass transition temperature and/or high melting temperature such that they provide a substantial degree of heat resistance to the polymer composition. For example, the polymer may have a melting temperature of about 250° C. or more, in some embodiments about 260° C., in some embodiments from about 270° C. to about 400° C., and in some embodiments, from about 275° C. to about 380° C. The aromatic polymer may also have a glass transition temperature of about 40° C. or more, in some embodiments about 50° C. or more, in some embodiments from about 60° C. to about 250° C., in some embodiments from about 70° C. to about 150° C. The glass transition and melting temperatures may be determined as is well known in the art using differential scanning calorimetry (“DSC”), such as determined by ISO Test No. 11357-2:2020 (glass transition) and 11357-3:2018 (melting).

Polyarylene sulfides, for instance, are suitable semi-crystalline aromatic polymers for use in the polymer composition. The polyarylene sulfide may be homopolymers or copolymers. For instance, selective combination of dihaloaromatic compounds can result in a polyarylene sulfide copolymer containing not less than two different units. For instance, when p-dichlorobenzene is used in combination with m-dichlorobenzene or 4,4′-dichlorodiphenylsulfone, a polyarylene sulfide copolymer can be formed containing segments having the structure of formula:

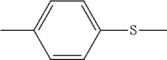

and segments having the structure of formula:

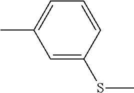

or segments having the structure of formula:

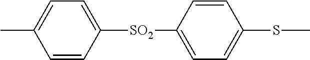

The polyarylene sulfide may be linear, semi-linear, branched, or crosslinked. Linear polyarylene sulfides typically contain 80 mol % or more of the repeating unit —(Ar—S)—. Such linear polymers may also include a small amount of a branching unit or a cross-linking unit, but the amount of branching or cross-linking units is typically less than about 1 mol % of the total monomer units of the polyarylene sulfide. A linear polyarylene sulfide polymer may be a random copolymer or a block copolymer containing the above-mentioned repeating unit. Semi-linear polyarylene sulfides may likewise have a cross-linking structure or a branched structure introduced into the polymer a small amount of one or more monomers having three or more reactive functional groups. By way of example, monomer components used in forming a semi-linear polyarylene sulfide can include an amount of polyhaloaromatic compounds having two or more halogen substituents per molecule which can be utilized in preparing branched polymers. Such monomers can be represented by the formula R′Xₙ, where each X is selected from chlorine, bromine, and iodine, n is an integer of 3 to 6, and R′ is a polyvalent aromatic radical of valence n which can have up to about 4 methyl substituents, the total number of carbon atoms in R′ being within the range of 6 to about 16. Examples of some polyhaloaromatic compounds having more than two halogens substituted per molecule that can be employed in forming a semi-linear polyarylene sulfide include 1,2,3-trichlorobenzene, 1,2,4-trichlorobenzene, 1,3-dichloro-5-bromobenzene, 1,2,4-triiodobenzene, 1,2,3,5-tetrabromobenzene, hexachlorobenzene, 1,3,5-trichloro-2,4,6-trimethylbenzene, 2,2′,4,4′-tetrachlorobiphenyl, 2,2′,5,5′-tetra-iodobiphenyl, 2,2′,6,6′-tetrabromo-3,3′,5,5′-tetramethylbiphenyl, 1,2,3,4-tetrachloronaphthalene, 1,2,4-tribromo-6-methylnaphthalene, etc., and mixtures thereof.

In addition to the polymers referenced above, crystalline polymers may also be employed in the polymer composition. Particularly suitable are liquid crystalline polymers, which have a high degree of crystallinity that enables them to effectively fill small spaces. Liquid crystalline polymers are generally classified as “thermotropic” to the extent that they can possess a rod-like structure and exhibit a crystalline behavior in their molten state (e.g., thermotropic nematic state). The liquid crystalline polymers employed in the polymer composition typically have a melting temperature of from about 250° C. to about 400° C., in some embodiments from about 260° C. to about 380° C., in some embodiments from about 270° C. to about 360° C., and in some embodiments from about 300° C. to about 350° C. Such polymers may be formed from one or more types of repeating units as is known in the art. A liquid crystalline polymer may, for example, contain one or more aromatic ester repeating units generally represented by the following Formula (I):

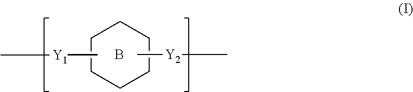

wherein,

ring B is a substituted or unsubstituted 6-membered aryl group (e.g., 1,4-phenylene or 1,3-phenylene), a substituted or unsubstituted 6-membered aryl group fused to a substituted or unsubstituted 5- or 6-membered aryl group (e.g., 2,6-naphthalene), or a substituted or unsubstituted 6-membered aryl group linked to a substituted or unsubstituted 5- or 6-membered aryl group (e.g., 4,4-biphenylene); and

Y₁ and Y₂ are independently O, C(O), NH, C(O)HN, or NHC(O).

Typically, at least one of Y₁ and Y₂ are C(O). Examples of such aromatic ester repeating units may include, for instance, aromatic dicarboxylic repeating units (Y₁ and Y₂ in Formula I are C(O)), aromatic hydroxycarboxylic repeating units (Y₁ is O and Y₂ is C(O) in Formula I), as well as various combinations thereof.

Aromatic hydroxycarboxylic repeating units, for instance, may be employed that are derived from aromatic hydroxycarboxylic acids, such as, 4-hydroxybenzoic acid; 4-hydroxy-4′-biphenylcarboxylic acid; 2-hydroxy-6-naphthoic acid; 2-hydroxy-5-naphthoic acid; 3-hydroxy-2-naphthoic acid; 2-hydroxy-3-naphthoic acid; 4′-hydroxyphenyl-4-benzoic acid; 3′-hydroxyphenyl-4-benzoic acid; 4′-hydroxyphenyl-3-benzoic acid, etc., as well as alkyl, alkoxy, aryl and halogen substituents thereof, and combination thereof. Particularly suitable aromatic hydroxycarboxylic acids are 4-hydroxybenzoic acid (“HBA”) and 6-hydroxy-2-naphthoic acid (“HNA”). When employed, repeating units derived from hydroxycarboxylic acids (e.g., HBA and/or HNA) typically constitute about 40 mol. % or more, in some embodiments about 50 mole % or more, in some embodiments from about 55 mol. % to 100 mol. %, and in some embodiments, from about 60 mol. % to about 95 mol. % of the polymer.

Aromatic dicarboxylic repeating units may also be employed that are derived from aromatic dicarboxylic acids, such as terephthalic acid, isophthalic acid, 2,6-naphthalenedicarboxylic acid, diphenyl ether-4,4′-dicarboxylic acid, 1,6-naphthalenedicarboxylic acid, 2,7-naphthalenedicarboxylic acid, 4,4′-dicarboxybiphenyl, bis(4-carboxyphenyl)ether, bis(4-carboxyphenyl)butane, bis(4-carboxyphenyl)ethane, bis(3-carboxyphenyl)ether, bis(3-carboxyphenyl)ethane, etc., as well as alkyl, alkoxy, aryl and halogen substituents thereof, and combinations thereof. Particularly suitable aromatic dicarboxylic acids may include, for instance, terephthalic acid (“TA”), isophthalic acid (“IA”), and 2,6-naphthalenedicarboxylic acid (“NDA”). When employed, repeating units derived from aromatic dicarboxylic acids (e.g., IA, TA, and/or NDA) typically constitute from about 1 mol. % to about 40 mol. %, in some embodiments from about 2 mol. % to about 30 mol. %, and in some embodiments, from about 5 mol. % to about 25 mol. % of the polymer.

Other repeating units may also be employed in the polymer. In certain embodiments, for instance, repeating units may be employed that are derived from aromatic diols, such as hydroquinone, resorcinol, 2,6-dihydroxynaphthalene, 2,7-dihydroxynaphthalene, 1,6-dihydroxynaphthalene, 4,4′-dihydroxybiphenyl (or 4,4′-biphenol), 3,3′-dihydroxybiphenyl, 3,4′-dihydroxybiphenyl, 4,4′-dihydroxybiphenyl ether, bis(4-hydroxyphenyl)ethane, etc., as well as alkyl, alkoxy, aryl and halogen substituents thereof, and combinations thereof. Particularly suitable aromatic diols may include, for instance, hydroquinone (“HQ”) and 4,4′-biphenol (“BP”). When employed, repeating units derived from aromatic diols (e.g., HQ and/or BP) typically constitute from about about 1 mol. % to about 40 mol. %, in some embodiments from about 2 mol. % to about 30 mol. %, and in some embodiments, from about 5 mol. % to about 25 mol. % of the polymer. Repeating units may also be employed, such as those derived from aromatic amides (e.g., acetaminophen (“APAP”)) and/or aromatic amines (e.g., 4-aminophenol (“AP”), 3-aminophenol, 1,4-phenylenediamine, 1,3-phenylenediamine, etc.). When employed, repeating units derived from aromatic amides (e.g., APAP) and/or aromatic amines (e.g., AP) typically constitute from about 0.1 mol. % to about 20 mol. %, in some embodiments from about 0.5 mol. % to about 15 mol. %, and in some embodiments, from about 1 mol. % to about 10% of the polymer. It should also be understood that various other monomeric repeating units may be incorporated into the polymer. For instance, in certain embodiments, the polymer may contain one or more repeating units derived from non-aromatic monomers, such as aliphatic or cycloaliphatic hydroxycarboxylic acids, dicarboxylic acids, diols, amides, amines, etc. Of course, in other embodiments, the polymer may be “wholly aromatic” in that it lacks repeating units derived from non-aromatic (e.g., aliphatic or cycloaliphatic) monomers.

Although not necessarily required, the liquid crystalline polymer may be a “high naphthenic” polymer to the extent that it contains a relatively high content of repeating units derived from naphthenic hydroxycarboxylic acids and naphthenic dicarboxylic acids, such as NDA, HNA, or combinations thereof. That is, the total amount of repeating units derived from naphthenic hydroxycarboxylic and/or dicarboxylic acids (e.g., NDA, HNA, or a combination of HNA and NDA) is typically about 40 mol. % or more, in some embodiments about 45 mol. % or more, in some embodiments about 50 mol. % or more, in some embodiments, in some embodiments about 55 mol. % or more, and in some embodiments, from about 60 mol. % to about 95 mol. % of the polymer. Contrary to many conventional “low naphthenic” polymers, it is believed that the resulting “high naphthenic” polymers are capable of exhibiting good thermal and mechanical properties. For instance, the repeating units derived from HNA may constitute from about 40 mol. % or more, in some embodiments about 50 mol. % or more, in some embodiments about 55 mol. % or more, and in some embodiments, from about 55 mol. % to about 85 mol. % of the polymer. In such embodiments, the liquid crystalline polymer may contain the naphthenic monomers (e.g., HNA and/or NDA) in the amounts specified above in combination with various other monomers, such as aromatic hydroxycarboxylic acid(s) (e.g., HBA) in an amount of from about 5 mol. % to about 50 mol. %, and in some embodiments, from about 10 mol. % to about 40 mol. %; aromatic dicarboxylic acid(s) (e.g., IA and/or TA) in an amount of from about 1 mol. % to about 40 mol. %, and in some embodiments, from about 5 mol. % to about 25 mol. %; and/or aromatic diol(s) (e.g., BP and/or HQ) in an amount of from about 1 mol. % to about 40 mol. %, and in some embodiments, from about 5 mol. % to about 25 mol. %.

Yet another suitable aromatic polymer is a polyaryletherketone, which is a semi-crystalline polymer with a relatively high melting temperature, such as from about 300° C. to about 400° C., in some embodiments from about 310° C. to about 390° C., and in some embodiments, from about 330° C. to about 380° C. The glass transition temperature may likewise be about 100° C. or more, in some embodiments from about 110° C. to about 200° C., and in some embodiments, from about 130° C. to about 160° C. The “neat” polyaryletherketone may have a relatively high melt viscosity. In one particular embodiment, for example, the polyaryletherketone may have a melt viscosity of about 80 Pa-s or more, in some embodiments about 110 Pa-s or more, in some embodiments from about 120 to about 250 Pa-s, and in some embodiments, from about 130 to about 220 Pa-s, determined at a shear rate of 1000 seconds⁻¹. Melt viscosity may be determined in accordance with ISO Test No. 11443:2014 at a temperature of 400° C.

Polyaryletherketones typically contain a moiety having the structure of Formula (II) and/or Formula (III):

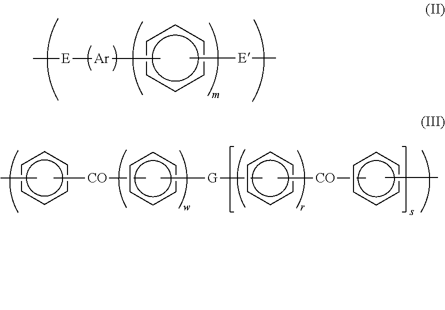

wherein,

m and r are independently zero or a positive integer, in some embodiments from 0 to 3, in some embodiments from 0 to 2, and in some embodiments, 0 or 1;

s and w are independently zero or a positive integer, in some embodiments from 0 to 2, and in some embodiments, 0 or 1;

E and E′ are independently an oxygen atom or a direct link;

G is an oxygen atom, a direct link, or —O-Ph-O— where Ph is a phenyl group; and

Ar is one of the following moieties (i) to (vi), which is bonded via one or more of phenyl moieties to adjacent moieties:

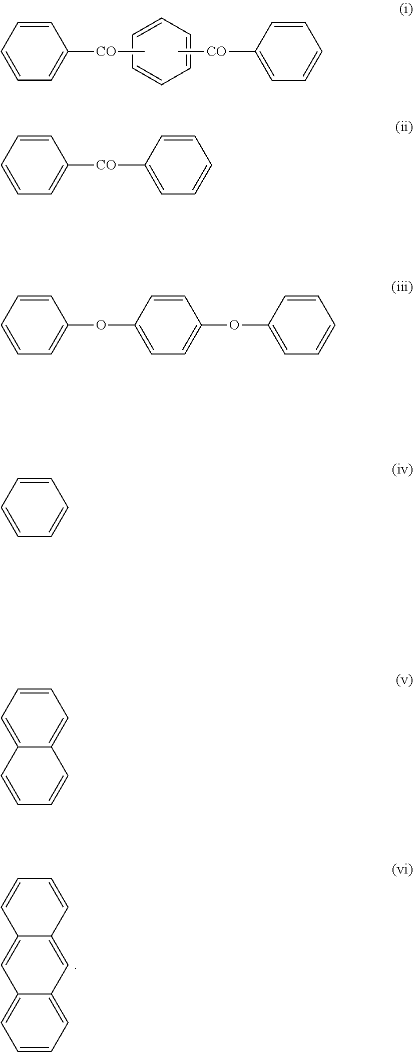

The polyaryletherketone may include more than one different type of repeat unit of Formula (II) and/or more than one different type of repeat unit of Formula (III). Typically, however, only one type of repeat unit of Formula (II) or Formula (III) is provided. In one particular embodiment, for example, the polyaryletherketone is a homopolymer or copolymer containing a repeat unit of the following general Formula (IV):

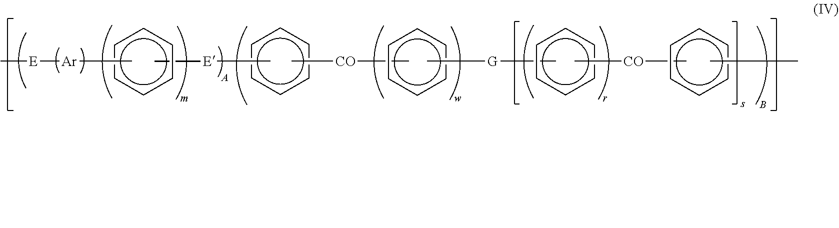

wherein,

A and B are independently 0 or 1; and

E, E′, G, Ar, m, r, s and w are as described above.

In yet another embodiment, the polyaryletherketone is a homopolymer or copolymer containing a repeat unit of the following general Formula (V):

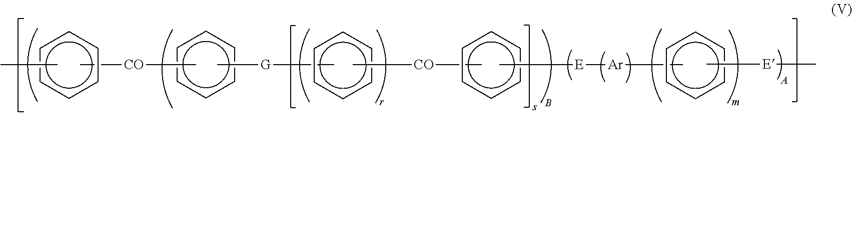

wherein,

A and B are independently 0 or 1; and

E, E′, G, Ar, m, r, s and w are as described above.

Desirably, Ar in the embodiments above is selected from the following moieties (vii) to (xiii):

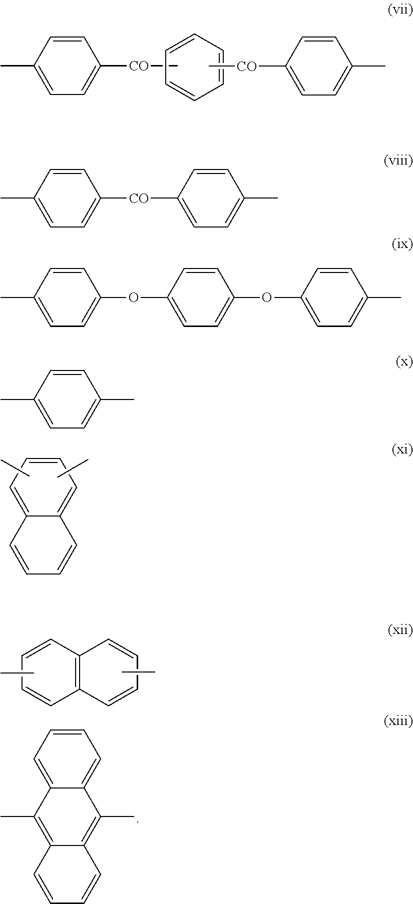

Particularly suitable polyaryletherketone polymers (or copolymers) are those of Formula (IV) that primarily include phenyl moieties in conjunction with ketone and/or ether moieties. Examples of such polymers include polyetheretherketone (“PEEK”) (wherein in Formula (IV), Ar is moiety (iv), E and E′ are oxygen atoms, m is 0, w is 1, G is a direct link, s is 0, and A and B are 1); polyetherketone (“PEK”) (wherein in Formula (IV), E is an oxygen atom, E′ is a direct link, Ar is moiety (i), m is 0, A is 1, B is 0); polyetherketoneketone (“PEKK”) (wherein in Formula (IV), E is an oxygen atom, Ar is moiety (i), m is 0, E′ is a direct link, A is 1, and B is 0); polyetherketoneetherketoneketone (“PEKEKK”) (wherein in Formula (IV), Ar is moiety (i), E and E′ are oxygen atoms, G is a direct link, m is 0, w is 1, r is 0, s is 1, and A and B are 1); polyetheretherketoneketone (“PEEKK”) (wherein in Formula (IV), Ar is moiety (iv), E and E′ are oxygen atoms, G is a direct link, m is 0, w is 0, and s, r, A and B are 1); polyether-diphenyl-ether-ether-diphenyl-ether-phenyl-ketone-phenyl (wherein in Formula (IV), Ar is moiety (iv), E and E′ are oxygen atoms, m is 1, w is 1, A is 1, B is 1, r and s are 0, and G is a direct link); as well as blends and copolymers thereof.

B. Polyamide

The polymer composition also contains from about 10 to about 80 parts by weight, in some embodiments from about 20 to about 70 parts by weight, and in some embodiments, from about 25 parts to about 50 parts by weight of at least one polyamide per 100 parts of the aromatic polymer(s). For example, polyamides may constitute from about 0.5 wt. % to about 30 wt. %, in some embodiments from about 1 wt. % to about 25 wt. %, and in some embodiments, from about 5 wt. % to about 20 wt. % of the composition.

Polyamides generally have a CO—NH linkage in the main chain and are obtained by condensation of a diamine and a dicarboxylic acid, by ring opening polymerization of lactam, or self-condensation of an amino carboxylic acid. For example, the polyamide may contain aliphatic repeating units derived from an aliphatic diamine, which typically has from 4 to 14 carbon atoms. Examples of such diamines include linear aliphatic alkylenediamines, such as 1,4-tetramethylenediamine, 1,6-hexanediamine, 1,7-heptanediamine, 1,8-octanediamine, 1,9-nonanediamine, 1,10-decanediamine, 1,11-undecanediamine, 1,12-dodecanediamine, etc.; branched aliphatic alkylenediamines, such as 2-methyl-1,5-pentanediamine, 3-methyl-1,5 pentanediamine, 2,2,4-trimethyl-1,6-hexanediamine, 2,4,4-trimethyl-1,6-hexanediamine, 2,4-dimethyl-1,6-hexanediamine, 2-methyl-1,8-octanediamine, 5-methyl-1,9-nonanediamine, etc.; as well as combinations thereof. Of course, aromatic and/or alicyclic diamines may also be employed. Furthermore, examples of the dicarboxylic acid component may include aromatic dicarboxylic acids (e.g., terephthalic acid, isophthalic acid, 2,6-naphthalenedicarboxylic acid, 2,7-naphthalenedicarboxylic acid, 1,4-naphthalenedicarboxylic acid, 1,4-phenylenedioxy-diacetic acid, 1,3-phenylenedioxy-diacetic acid, diphenic acid, 4,4′-oxydibenzoic acid, diphenylmethane-4,4′-dicarboxylic acid, diphenylsulfone-4,4′-dicarboxylic acid, 4,4′-biphenyldicarboxylic acid, etc.), aliphatic dicarboxylic acids (e.g., adipic acid, sebacic acid, etc.), and so forth. Examples of lactams include pyrrolidone, aminocaproic acid, caprolactam, undecanlactam, lauryl lactam, and so forth. Likewise, examples of amino carboxylic acids include amino fatty acids, which are compounds of the aforementioned lactams that have been ring opened by water.

In certain embodiments, an “aliphatic” polyamide is employed that is formed only from aliphatic monomer units (e.g., diamine and dicarboxylic acid monomer units). Particular examples of such aliphatic polyamides include, for instance, nylon-4 (poly-α-pyrrolidone), nylon-6 (polycaproamide), nylon-11 (polyundecanamide), nylon-12 (polydodecanamide), nylon-46 (polytetramethylene adipamide), nylon-66 (polyhexamethylene adipamide), nylon-610, and nylon-612. Nylon-6 and nylon-66 are particularly suitable. In one particular embodiment, for example, nylon-6 or nylon-66 may be used alone. In other embodiments, blends of nylon-6 and nylon-66 may be employed. When such a blend is employed, the weight ratio of nylon-66 to nylon-6 is typically from 1 to about 2, in some embodiments from about 1.1 to about 1.8, and in some embodiments, from about 1.2 to about 1.6.

Of course, it is also possible to include aromatic monomer units in the polyamide such that it is considered semi-aromatic (contains both aliphatic and aromatic monomer units) or wholly aromatic (contains only aromatic monomer units). For instance, suitable semi-aromatic polyamides may include poly(nonamethylene terephthalamide) (PA9T), poly(nonamethylene terephthalamide/nonamethylene decanediamide) (PA9T/910), poly(nonamethylene terephthalamide/nonamethylene dodecanediamide) (PA9T/912), poly(nonamethylene terephthalamide/11-aminoundecanamide) (PA9T/11), poly(nonamethylene terephthalamide/12-aminododecanamide) (PA9T/12), poly(decamethylene terephthalamide/11-aminoundecanamide) (PA10T/11), poly(decamethylene terephthalamide/12-aminododecanamide) (PA10T/12), poly(decamethylene terephthalamide/decamethylene decanediamide) (PA10T/1010), poly(decamethylene terephthalamide/decamethylene dodecanediamide) (PA10T/1012), poly(decamethylene terephlhalamide/tetramethylene hexanediamide) (PA10T/46), poly(decamethylene terephthalamide/caprolactam) (PA10T/6), poly(decamethylene terephthalamide/hexamethylene hexanediamide) (PA10T/66), poly(dodecamethylene lerephthalamide/dodecamelhylene dodecanediarnide) (PA12T/1212), poly(dodecamethylene terephthalamide/caprolactam) (PA12T/6), poly(dodecamethylene terephthalamide/hexamethylene hexanediamide) (PA12T/66), and so forth.

The polyamide employed in the polymer composition is typically crystalline or semi-crystalline in nature and thus has a measurable melting temperature. The melting temperature may be relatively high such that the composition can provide a substantial degree of heat resistance to a resulting part. For example, the polyamide may have a melting temperature of about 220° C. or more, in some embodiments from about 240° C. to about 325° C., and in some embodiments, from about 250° C. to about 335° C. The polyamide may also have a relatively high glass transition temperature, such as about 30° C. or more, in some embodiments about 40° C. or more, and in some embodiments, from about 45° C. to about 140° C. The glass transition and melting temperatures may be determined as is well known in the art using differential scanning calorimetry (“DSC”), such as determined by ISO Test No. 11357-2:2020 (glass transition) and 11357-3:2018 (melting).

C. Aluminum Hydroxide Particles

As noted above, the polymer composition also contains an aluminum hydroxide particles to help achieve the desired properties. For instance, the particles generally contain at least one aluminum hydroxide having the general formula: Al(OH)ₐO_{b}, where 0≤a≤3 (e.g., 1) and b=(3−a)/2. In one particular embodiment, for example, the particles exhibit a boehmite crystal phase and the aluminum hydroxide has the formula AlO(OH) (“aluminum oxide hydroxide”). The aluminum hydroxide particles may be needle-shaped, ellipsoidal-shaped, platelet-shaped, spherical-shaped, etc. Regardless, the particles typically have a median particle diameter (D50) of from about 50 to about 800 nanometers, in some embodiments from about 150 to about 700 nanometers, and in some embodiments, from about 250 to about 500 nanometers, as determined by non-invasive back scatter (NIBS) techniques. If desired, the particles may also have a high specific surface area, such as from about 2 square meters per gram (m²/g) to about 100 m²/g, in some embodiments from about 5 m²/g to about 50 m²/g, and in some embodiments, from about 10 m²/g to about 30 m²/g. Surface area may be determined by the physical gas adsorption (BET) method (nitrogen as the adsorption gas) in accordance with ISO 9277:2010. The moisture content may also be relatively low, such as about 5% or less, in some embodiments about 3% or less, and in some embodiments, from about 0.1 to about 1% as determined in accordance with ISO 787-2:1981.

D. Reinforcing Fibers

Although by no means required, reinforcing fibers may be employed in certain embodiments of the present invention. Any of a variety of different types of reinforcing fibers may generally be employed in the polymer composition, such as polymer fibers, metal fibers, carbonaceous fibers (e.g., graphite, carbide, etc.), inorganic fibers, etc., as well as combinations thereof. Inorganic fibers may be particularly suitable, such as those that are derived from glass; titanates (e.g., potassium titanate); silicates, such as neosilicates, sorosilicates, inosilicates (e.g., calcium inosilicates, such as wollastonite; calcium magnesium inosilicates, such as tremolite; calcium magnesium iron inosilicates, such as actinolite; magnesium iron inosilicates, such as anthophyllite; etc.), phyllosilicates (e.g., aluminum phyllosilicates, such as palygorskite), tectosilicates, etc.; sulfates, such as calcium sulfates (e.g., dehydrated or anhydrous gypsum); mineral wools (e.g., rock or slag wool); and so forth. Glass fibers may be particularly suitable for use in the present invention, such as those formed from E-glass, A-glass, C-glass, D-glass, AR-glass, R-glass, S1-glass, S2-glass, etc., as well as mixtures thereof. If desired, the reinforcing fibers may be provided with a sizing agent or other coating as is known in the art. Regardless of the particular type selected, it is generally desired that the fibers have a relatively low elastic modulus to enhance the processability of the resulting polymer composition. The fibers may, for instance, have a Young's modulus of elasticity of less than about 76 GPa, in some embodiments less than about 75 GPa, and in some embodiments, from about 10 to about 74 GPa, as determined in accordance with ASTM C1557-14.

If desired, at least a portion of the reinforcing fibers may have a relatively flat cross-sectional dimension in that they have an aspect ratio of from about 1.5 to about 10, in some embodiments from about 2 to about 8, and in some embodiments, from about 3 to about 5. The aspect ratio is determined by dividing the cross-sectional width of the fibers (i.e., in the direction of the major axis) by the cross-sectional thickness of the fibers (i.e., in the direction of the minor axis). The shape of such fibers may be in the form of an ellipse, rectangle, rectangle with one or more rounded corners, etc. The cross-sectional width of the fibers may be from about 1 to about 50 micrometers, in some embodiments from about 5 to about 45 micrometers, and in some embodiments, from about 10 to about 35 micrometers. The fibers may also have a thickness of from about 0.5 to about 30 micrometers, in some embodiments from about 1 to about 20 micrometers, and in some embodiments, from about 3 to about 15 micrometers. It should be understood that the cross-sectional thickness and/or width need not be uniform over the entire cross-section. In such circumstances, the cross-sectional width is considered as the largest dimension along the major axis of the fiber and the cross-sectional thickness is considered as the largest dimension along the minor axis. For example, the cross-sectional thickness for an elliptical fiber is the minor diameter of the ellipse.

The reinforcing fibers may also have a narrow size distribution. That is, at least about 60% by volume of the fibers, in some embodiments at least about 70% by volume of the fibers, and in some embodiments, at least about 80% by volume of the fibers may have a width and/or thickness within the ranges noted above. The fibers may be endless or chopped fibers, such as those having a length of from about 1 to about 15 millimeters, and in some embodiments, from about 2 to about 6 millimeters. The dimension of the fibers (e.g., length, width, and thickness) may be determined using known optical microscopy techniques.

When employed, the amount of reinforcing fibers may be selectively controlled to achieve the desired combination of CTI, flow, and mechanical properties. The reinforcing fibers may, for example, be employed in an amount of from about 40 to about 250 parts, in some embodiments from about 60 to about 220 parts, and in some embodiments, from about 100 to about 200 parts per 100 parts by weight of aromatic polymer(s) employed in the polymer composition. The reinforcing fibers may, for instance, constitute from about 5 wt. % to about 60 wt. %, in some embodiments from about 10 wt. % to about 50 wt. %, and in some embodiments, from about 20 wt. % to about 45 wt. % of the polymer composition. 12. The relative portion of the reinforcing fibers to the aluminum hydroxide particles may also be selectively controlled. For example, the weight ratio of the reinforcing fibers to such particles may be from about 1 to about 2, in some embodiments from about 1.1 to about 1.9, and in some embodiments, from about 1.3 to about 1.8.

E. Other Components

A wide variety of additional additives can also be included in the polymer composition, such as organosilane compounds, impact modifiers, lubricants, pigments, antioxidants, UV stabilizers, surfactants, waxes, flame retardants, anti-drip additives, additional polymers, and other materials added to enhance properties and processability. In certain embodiments, for instance, the polymer composition may contain an organosilane compound to help improve the compatibility between the aromatic polymer and the filler components (e.g., fibrous filler). When employed, such organosilane compounds typically constitute from about 0.05 to about 3 parts by weight, in some embodiments from about 0.1 parts to about 2 parts by weight, and in some embodiments, from about 0.2 parts to about 1.5 parts per 100 parts by weight of aromatic polymer(s) employed in the polymer composition. For example, such compounds may constitute from about 0.01 wt. % to about 3 wt. %, in some embodiments from about 0.02 wt. % to about 1 wt. %, and in some embodiments, from about 0.05 wt. % to about 0.5 wt. % of the polymer composition.

The organosilane compound may, for example, be any alkoxysilane as is known in the art, such as vinlyalkoxysilanes, epoxyalkoxysilanes, aminoalkoxysilanes, mercaptoalkoxysilanes, and combinations thereof. In one embodiment, for instance, the organosilane compound may have the following general formula:

R⁵—Si—(R⁶)₃,

wherein,

R⁵ is a sulfide group (e.g., —SH), an alkyl sulfide containing from 1 to 10 carbon atoms (e.g., mercaptopropyl, mercaptoethyl, mercaptobutyl, etc.), alkenyl sulfide containing from 2 to 10 carbon atoms, alkynyl sulfide containing from 2 to 10 carbon atoms, amino group (e.g., NH₂), aminoalkyl containing from 1 to 10 carbon atoms (e.g., aminomethyl, aminoethyl, aminopropyl, aminobutyl, etc.); aminoalkenyl containing from 2 to 10 carbon atoms, aminoalkynyl containing from 2 to 10 carbon atoms, and so forth;

R⁶ is an alkoxy group of from 1 to 10 carbon atoms, such as methoxy, ethoxy, propoxy, and so forth.

Some representative examples of organosilane compounds that may be included in the mixture include mercaptopropyl trimethyoxysilane, mercaptopropyl triethoxysilane, aminopropyl triethoxysilane, aminoethyl triethoxysilane, aminopropyl trimethoxysilane, aminoethyl trimethoxysilane, ethylene trimethoxysilane, ethylene triethoxysilane, ethyne trimethoxysilane, ethyne triethoxysilane, aminoethylaminopropyltrimethoxysilane, 3-aminopropyl triethoxysilane, 3-aminopropyl trimethoxysilane, 3-aminopropyl methyl dimethoxysilane or 3-aminopropyl methyl diethoxysilane, N-(2-aminoethyl)-3-aminopropyl trimethoxysilane, N-methyl-3-aminopropyl trimethoxysilane, N-phenyl-3-aminopropyl trimethoxysilane, bis(3-aminopropyl) tetramethoxysilane, bis(3-aminopropyl) tetraethoxy disiloxane, γ-aminopropyltrimethoxysilane, γ-aminopropyltriethoxysilane, γ-aminopropylmethyldimethoxysilane, γ-aminopropylmethyldiethoxysilane, N-(β-aminoethyl)-γ-aminopropyltrimethoxysilane, N-phenyl-γ-aminopropyltrimethoxysilane, γ-diallylaminopropyltrimethoxysilane, γ-diallylaminopropyltrimethoxysilane, etc., as well as combinations thereof. Particularly suitable organosilane compounds are 3-aminopropyltriethoxysilane and 3-mercaptopropyltrimethoxysilane.

Regardless of the particular components employed, the aromatic polymer, polyamide, aluminum hydroxide particles, and other optional additives may be melt processed or blended together. The components may be supplied separately or in combination to an extruder that includes at least one screw rotatably mounted and received within a barrel (e.g., cylindrical barrel) and may define a feed section and a melting section located downstream from the feed section along the length of the screw. If desired, the aluminum hydroxide particles or other optional additives (e.g., reinforcing fibers) may be added a location downstream from the point at which the aromatic polymer and/or polyamide are supplied (e.g., hopper) to minimize degradation. One or more of the sections of the extruder are typically heated, such as within a temperature range of from about 250° C. to about 450° C., in some embodiments, from about 260° C. to about 350° C., and in some embodiments, from about 270° C. to about 350° C. to form the composition. The speed of the screw may be selected to achieve the desired residence time, shear rate, melt processing temperature, etc. For example, the screw speed may range from about 50 to about 800 revolutions per minute (“rpm”), in some embodiments from about 100 to about 600 rpm, and in some embodiments, from about 150 to about 500 rpm. The apparent shear rate during melt blending may also range from about 100 seconds⁻¹ to about 10,000 seconds⁻¹, in some embodiments from about 500 seconds⁻¹ to about 5000 seconds⁻¹, and in some embodiments, from about 800 seconds⁻¹ to about 1200 seconds⁻¹. The apparent shear rate is equal to 4Q/πR³, where Q is the volumetric flow rate (“m³/s”) of the polymer melt and R is the radius (“m”) of the capillary (e.g., extruder die) through which the melted polymer flows.

The resulting polymer composition can possess excellent thermal properties. For example, the melt viscosity of the polymer composition may be low enough so that it can readily flow into the cavity of a mold having small dimensions. In one particular embodiment, the polymer composition may have a melt viscosity of from about 50 to about 1,000 Pascal-seconds (“Pa-s”), in some embodiments from about 100 to about 800 Pa-s, and in some embodiments, from about 200 to about 500 Pa-s, determined at a shear rate of 1,200 seconds⁻¹. Melt viscosity may be determined in accordance with ISO Test No. 11443:2014, such as at a temperature of about 30° C. above the melting temperature of the aromatic polymer, such as 310° C. for polyphenylene sulfide (melting temperature of about 280° C.).

### III. Electric Vehicle

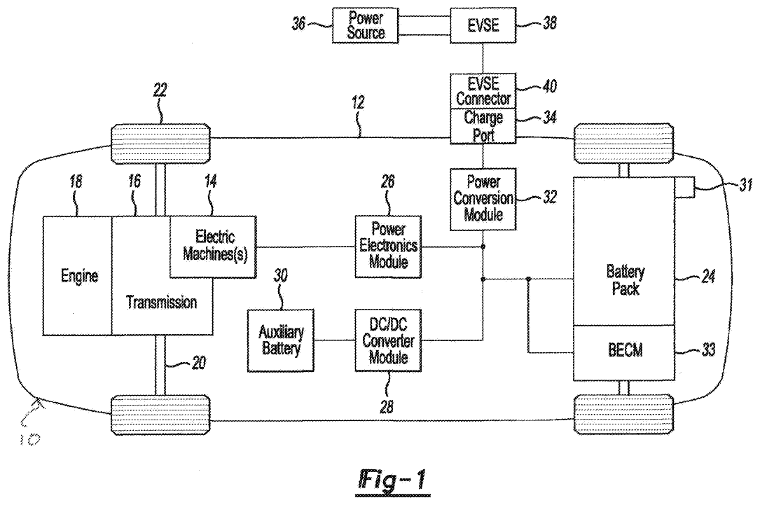

As noted above, the polymer composition is particularly well suited for use in an electric vehicle. Referring to FIG. 1, for instance, one embodiment of an electric vehicle 12 that includes a powertrain 10 is shown. The powertrain 10 contains one or more electric machines 14 connected to a transmission 16, which in turn is mechanically connected to a drive shaft 20 and wheels 22. Although by no means required, the transmission 16 in this particular embodiment is also connected to an engine 18. The electric machines 14 may be capable of operating as a motor or a generator to provide propulsion and deceleration capability. The powertrain 10 also includes a propulsion source, such as a battery pack 24, which stores and provides energy for use by the electric machines 14. The battery pack 24 typically provides a high voltage current output (e.g., DC current) from one or more battery cell arrays that may include one or more battery cells.

The powertrain 10 may also contain at least one power electronics module 26 that is connected to the battery pack 24 and that may contain a power converter (e.g., inverter, rectifier, voltage converter, etc., as well as combinations thereof). The power electronics module 26 is typically electrically connected to the electric machines 14 and provides the ability to bi-directionally transfer electrical energy between the battery pack 24 and the electric machines 14. For example, the battery pack 24 may provide a DC voltage while the electric machines 14 may require a three-phase AC voltage to function. The power electronics module 26 may convert the DC voltage to a three-phase AC voltage as required by the electric machines 14. In a regenerative mode, the power electronics module 26 may convert the three-phase AC voltage from the electric machines 14 acting as generators to the DC voltage required by the battery pack 24. The description herein is equally applicable to a pure electric vehicle. The battery pack 24 may also provide energy for other vehicle electrical systems. For example, the powertrain may employ a DC/DC converter module 28 that converts the high voltage DC output from the battery pack 24 to a low voltage DC supply that is compatible with other vehicle loads, such as compressors and electric heaters. In a typical vehicle, the low-voltage systems are electrically connected to an auxiliary battery 30 (e.g., 12V battery). A battery energy control module (BECM) 33 may also be present that is in communication with the battery pack 24 that acts as a controller for the battery pack 24 and may include an electronic monitoring system that manages temperature and charge state of each of the battery cells. The battery pack 24 may also have a temperature sensor 31, such as a thermistor or other temperature gauge. The temperature sensor 31 may be in communication with the BECM 33 to provide temperature data regarding the battery pack 24. The temperature sensor 31 may also be located on or near the battery cells within the traction battery 24. It is also contemplated that more than one temperature sensor 31 may be used to monitor temperature of the battery cells.

In certain embodiments, the battery pack 24 may be recharged by an external power source 36, such as an electrical outlet. The external power source 36 may be electrically connected to electric vehicle supply equipment (EVSE) that regulates and manages the transfer of electrical energy between the power source 36 and the vehicle 12. The EVSE 38 may have a charge connector 40 for plugging into a charge port 34 of the vehicle 12. The charge port 34 may be any type of port configured to transfer power from the EVSE 38 to the vehicle 12 and may be electrically connected to a charger or on-board power conversion module 32. The power conversion module 32 may condition the power supplied from the EVSE 38 to provide the proper voltage and current levels to the battery pack 24. The power conversion module 32 may interface with the EVSE 38 to coordinate the delivery of power to the vehicle 12.

The polymer composition of the present invention may be employed in various aspects of the vehicle 12, such as in the transmission 16, powertrain 10, etc. When employed in the powertrain 10, for example, the polymer composition may be employed in the battery pack 24, power conversion module 32, battery energy control module (BECM) 33, etc. In such embodiments, the polymer composition is typically used to form the housing of such components. In one embodiment, for instance, the polymer composition may be employed within a housing of a power electronic module that contains a power converter (e.g., inverter, rectifier, voltage converter, etc., as well as combinations thereof). The housing may, for instance, include a base that contains a sidewall extending therefrom. A cover may also be supported on the sidewall of the base to define an interior within which the electronic component(s) are received and protected from the exterior environment. Regardless of the particular configuration of the module, the polymer composition may be used to form all or a portion of the housing and/or cover. In one embodiment, for instance, the polymer composition may be used to form the base and sidewall of the housing. In such embodiments, the cover may be formed from the polymer composition or from a different material, such as a metal component (e.g., aluminum plate).

The polymer composition may generally be employed to form the housing or a portion of the housing using a variety of different shaping techniques. Suitable techniques may include, for instance, injection molding, low-pressure injection molding, extrusion compression molding, gas injection molding, foam injection molding, low-pressure gas injection molding, low-pressure foam injection molding, gas extrusion compression molding, foam extrusion compression molding, extrusion molding, foam extrusion molding, compression molding, foam compression molding, gas compression molding, etc. For example, an injection molding system may be employed that includes a mold within which the composition may be injected. The time inside the injector may be controlled and optimized so that polymer matrix is not pre-solidified. When the cycle time is reached and the barrel is full for discharge, a piston may be used to inject the composition to the mold cavity. Compression molding systems may also be employed. As with injection molding, the shaping of the composition into the desired article also occurs within a mold. The composition may be placed into the compression mold using any known technique, such as by being picked up by an automated robot arm. The temperature of the mold may be maintained at or above the solidification temperature of the polymer matrix for a desired time period to allow for solidification. The molded product may then be solidified by bringing it to a temperature below that of the melting temperature. The resulting product may be de-molded. The cycle time for each molding process may be adjusted to suit the polymer matrix, to achieve sufficient bonding, and to enhance overall process productivity. Due to the unique properties of the composition, relatively thin shaped housing portions (e.g., injection molded parts) can be readily formed therefrom. For example, such housing portions may have a thickness of about 10 millimeters or less, in some embodiments about 8 millimeters or less, in some embodiments about 6 millimeters or less, in some embodiments from about 0.4 to about 5 millimeters, and in some embodiments, from about 0.8 to about 4 millimeters (e.g., 0.8, 1.2. or 3 millimeters).

The polymer composition may also be employed in a high voltage connector that is used to connect together various components of the electric vehicle. Referring again to FIG. 1, for instance, a high voltage connector (not shown) may electrically connect the battery pack 24 to a power electronics module, such as the power electronics module 26, the DC/DC converter module 28, and/or the power conversion module 32. The high voltage connector (not shown) may also electrically connect a power electronics module (e.g., module 32) to certain electric machines 14 and/or the power electronics module and/or electric machines 14 to the transmission 16.

The high voltage connector may have a variety of different configurations depending on the particular application in which it is employed. Typically, however, the connector contains a first connector portion that contains at least one electrical pin and a protection member extending from a base that surrounds at least a portion of the electrical pin. The base and/or the protection member may contain the polymer composition. For instance, in certain embodiments, the protection member may have a relatively small wall thickness, such as about 4 millimeters or less, in some embodiments about from about 0.2 to about 3.2 millimeters or less, in some embodiments from about 0.4 to about 1.6 millimeters, and in some embodiments, from about 0.4 to about 0.8 millimeters. The first connector portion may be configured to mate with an opposing second connector portion that contains a receptacle for receiving the electrical pin. In such embodiments, the second connector portion may contain at least one receptable configured to receive the electrical pin of the first connector portion and a protection member extending from a base that surrounds at least a portion of receptacle. The base and/or the protection member of the second connector portion may also contain the polymer composition. For instance, in certain embodiments, the thickness of the protection member of the second connector portion may be within the ranges noted above and thus beneficially formed from the polymer composition.

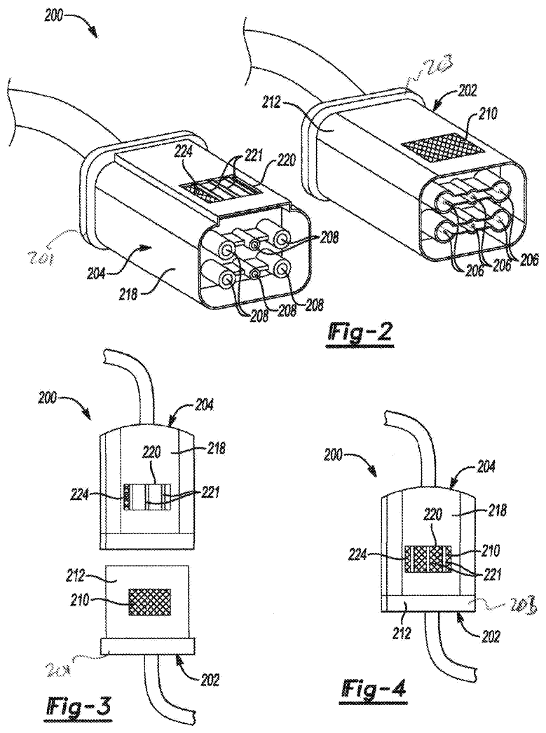

Referring to FIGS. 2-4, one particular embodiment of a high voltage connector 200 is shown for use in an electric vehicle powertrain. The connector 200 contains a first connector portion 202 and a second connector portion 204. The first connector portion 202 may include one or more electrical pins 206 and the second connector portion 204 may include one or more receptacles 208 for receiving the electrical pins 206. A first protection member 212 may extend from a base 203 of the first connecting portion 202 to surround the pins 206, and similarly, a second protection member 218 may extend from a base 201 of the second connecting portion 204 to surround the receptacles 208. In certain cases, the periphery of the first protective member 212 may extend beyond an end of the electrical pins 203 and the periphery of the second protective member 218 may extend beyond an end of the receptacles 208. As noted above, the base 203 and/or the first protection member 212 of the first connector portion 202, as well as the base 201 and/or the second protection member 218 of the second connector portion 204, may be formed from the polymer composition of the present invention, such as using the techniques described above. Although by no means required, the first connector portion 202 may also include an identification mark 210 secured to or defined by the first protective member 212. The second connecting portion 204 may also optionally define an alignment window 220 sized according to the identification mark 210 to more easily determine when the portions are fully mated. For instance, the identification mark 210 may not be readable unless blockers 221 cover a portion of the identification mark 210. Optionally, the second connecting portion 204 may include a supplemental mark 224 located adjacent to the alignment window 220.

Of course, apart from being used in the electric vehicle itself, the polymer composition may also be employed in various other accessories that are designed to be used with an electric vehicle. For example, the polymer composition may be employed in a charging station, such as in the housing that surrounds components for charging the vehicle. One example of such a charging station is, for instance, described in U.S. Patent Publication No. 2014/0021908 to McCool, et al. The housing may include an outer body surrounding an interior and a removable cover allowing access to the interior of the housing body. The interior receives and retains components associated with charging the vehicle and performing various other operations as described herein. The outer body and/or cover may be formed from the polymer composition.

The present invention may be better understood with reference to the following examples.

### Test Methods

Melt Viscosity: Melt viscosity may be determined in accordance with ISO Test No. 11443:2014 at a shear rate of 1,200 s⁻¹ using a Dynisco 7001 capillary rheometer. The rheometer orifice (die) had a diameter of 1 mm, length of 20 mm, L/D ratio of 20.1, and an entrance angle of 180°. The diameter of the barrel was 9.55 mm±0.005 mm and the length of the rod was 233.4 mm. The temperature is typically about 30° C. above the melting temperature of the aromatic polymer. For polyphenylene sulfide, for instance, the melt viscosity may be determined at a temperature of about 310° C.

Tensile Modulus and Tensile Strength: Tensile properties may be tested according to ISO Test No. 527:2019 (technically equivalent to ASTM D638-14). Modulus and strength measurements may be made on the same test strip sample having a length of 80 mm, thickness of 10 mm, and width of 4 mm. The testing temperature may be 23° C., and the testing speeds may be 1 or 5 mm/min.

Notched Charpy Impact Strength: Notched Charpy properties may be tested according to ISO Test No. ISO 179-1:2010) (technically equivalent to ASTM D256-10, Method B). This test may be run using a Type A notch (0.25 mm base radius) and Type 1 specimen size (length of 80 mm, width of 10 mm, and thickness of 4 mm). Specimens may be cut from the center of a multi-purpose bar using a single tooth milling machine. The testing temperature may be 23° C.

Comparative Tracking Index (“CTI”): The comparative tracking index (CTI) may be determined in accordance with International Standard IEC 60112-2003 to provide a quantitative indication of the ability of a composition to perform as an electrical insulating material under wet and/or contaminated conditions. In determining the CTI rating of a composition, two electrodes are placed on a molded test specimen. A voltage differential is then established between the electrodes while a 0.1% aqueous ammonium chloride solution is dropped onto a test specimen. The maximum voltage at which five (5) specimens withstand the test period for 50 drops without failure is determined. The test voltages range from 100 to 600 V in 25 V increments. The numerical value of the voltage that causes failure with the application of fifty (50) drops of the electrolyte is the “comparative tracking index.” The value provides an indication of the relative track resistance of the material. According to UL746A, a nominal part thickness of 3 mm is considered representative of performance at other thicknesses.

### Comparative Examples 1-3

Three (3) comparative resin samples are formed from the components listed in the table below.

| | Comp. | Comp. | Comp. |
|---|---|---|---|
| | Ex. 1 | Ex. 2 | Ex. 3 |
| | (wt. %) | (wt. %) | (wt. %) |
| PPS | 34.7 | 34.7 | 24.7 |
| Nylon 66 | — | — | 10 |
| Glass Fibers | 35 | 35 | 35 |
| Lubricant | 0.3 | 0.3 | 0.3 |
| Magnesium Hydroxide | 30 | — | 30 |
| Aluminum Oxide-Hydroxide (AIO(OH)) | — | 30 | — |

Once formed, the resulting compositions were then injected molded and tested for various properties as described above. The results are set forth below.

| | Comp. | Comp. | Comp. |
|---|---|---|---|
| | Ex. 1 | Ex. 2 | Ex. 3 |
| Tensile Modulus (MPa) | 21,699 | 22,079 | 22,074 |
| Tensile Strength (MPa) | 93.1 | 106.6 | 70.6 |
| Charpy Notched at 23° C. (kJ/m²) | 4.0 | 3.8 | 6.0 |
| DTUL at 1.8 MPa (° C.) | 269 | 220 | 265 |
| CTI (V) | 300 | 300 | 550 |

### Examples 1-3

Three (3) resin samples are formed from the components listed in the table below.

| | Ex. 1 | Ex. 2 | Ex. 3 |
|---|---|---|---|
| | (wt. %) | (wt. %) | (wt. %) |
| PPS | 24.7 | 24.6 | 24.5 |
| Nylon 66 | 10 | 10 | 10 |
| Glass Fibers | 35 | 35 | 35 |
| Lubricant | 0.3 | 0.3 | 0.3 |
| Aminosilane Coupling Agent | — | 0.1 | 0.2 |
| Aluminum Oxide-Hydroxide (AIO(OH)) | 30 | 30 | 30 |

Once formed, the resulting compositions were then injected molded and tested for various properties as described above. The results are set forth below.

| | Ex. 1 | Ex. 2 | Ex. 3 |
|---|---|---|---|
| Tensile Modulus (MPa) | 22,248 | 22,138 | 21,834 |
| Tensile Strength (MPa) | 91.6 | 109.4 | 114.8 |
| Charpy Notched at 23° C. (kJ/m²) | 3.8 | 4.3 | 4.5 |
| DTUL at 1.8 MPa (° C.) | 259 | 257 | 259 |
| CTI (V) | 600 | 550 | 500 |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A polymer composition comprising:
100 parts by weight of at least one thermoplastic aromatic polymer having a melting temperature of about 250° C. or more;
from about 10 to about 80 parts by weight of at least one polyamide; and
from about 50 to about 250 parts by weight of aluminum hydroxide particles;
wherein the polymer composition exhibits a comparative tracking index of about 475 volts or more at a thickness of 3 mm as determined in accordance with IEC 60112:2003 and a tensile strength of about 75 MPa or more as determined in accordance with ISO Test No. 527-1:2019.

2. The polymer composition of claim 1, wherein the aromatic polymer has a melting temperature of from about 270° C. to about 400° C.

3. The polymer composition of claim 1, wherein the aromatic polymer has a glass transition temperature of about 40° C. or more.

4. The polymer composition of claim 1, wherein the aromatic polymer includes a polyarylene sulfide.

5. The polymer composition of claim 1, wherein the polyamide includes an aliphatic polyamide.

6. The polymer composition of claim 5, wherein the aliphatic polyamide includes nylon-6, nylon-6,6, or a combination thereof.

7. The polymer composition of claim 1, wherein the particles contain at least one aluminum hydroxide having the general formula: Al(OH)ₐO_{b}, where 0≤a≤3 and b=(3−a)/2.

8. The polymer composition of claim 7, wherein the aluminum hydroxide has the formula AlO(OH).

9. The polymer composition of claim 1, wherein the aluminum hydroxide particles have a median particle diameter of from about 50 to about 800 nanometers, a specific surface area of from about 2 to about 100 m²/g, and/or a moisture content of about 5% or less as determined in accordance with ISO 787-2:1981.

10. The polymer composition of claim 1, further comprising from about 50 to about 250 parts by weight of reinforcing fibers.

11. The polymer composition of claim 10, wherein the reinforcing fibers include glass fibers.

12. The polymer composition of claim 10, wherein the weight ratio of the reinforcing fibers to the aluminum hydroxide particles is from about 1 to about 2.

13. The polymer composition of claim 1, further comprising from about 0.05 to about 3 parts by weight of at least one organosilane compound.

14. An electric vehicle comprising a powertrain that includes at least one electric propulsion source and a transmission that is connected to the propulsion source via at least one power electronics module, wherein the electric vehicle comprises the polymer composition of claim 1.

15. The electric vehicle of claim 14, wherein the power electronics module contains a housing, wherein the housing includes the polymer composition.

16. The electric vehicle of claim 14, wherein the propulsion source contains a housing, wherein the housing includes the polymer composition.

17. The electric vehicle of claim 14, wherein the transmission includes the polymer composition.

18. The electric vehicle of claim 14, wherein a high voltage connector electrically connects the propulsion source to the power electronics module and/or the power electronics module to the transmission, wherein the high voltage connector includes the polymer composition.

19. A station for charging an electric vehicle, wherein the station includes the polymer composition of claim 1.

20. The station of claim 19, wherein the station contains a housing, wherein the housing includes the polymer composition.
